(19) United States
(12) Patent Application Publication
(10) Pub. No.: US 2014/0063237 A1
(43) Pub. Date: Mar. 6, 2014

(54) SYSTEM AND METHOD FOR ANONYMOUS OBJECT IDENTIFIER GENERATION AND USAGE FOR TRACKING

(71) Applicants: Douglas M. Stone, Placerville, CA (US); Brian C. Wiles, Cameron Park, CA (US)

(72) Inventors: Douglas M. Stone, Placerville, CA (US); Brian C. Wiles, Cameron Park, CA (US)

(73) Assignee: Transportation Security Enterprises, Inc.(TSE), a Delaware corporation

(21) Appl. No.: 13/602,319

(22) Filed: Sep. 3, 2012

(51) Int. Cl. G06K 9/46; H04N 7/18

(52) U.S. Cl. 348/143; 382/190; 348/E07.085

(57) ABSTRACT

A system and method for anonymous object identifier generation and usage for tracking are disclosed. A particular embodiment includes: obtaining a frame from one of a plurality of data streams received from a plurality of sensor arrays deployed at a monitored venue; isolating a region surrounding an object of interest in the frame; performing feature extraction on the object of interest in the region; identifying patterns from the extracted features; normalizing the extracted features based on the identified patterns; quantifying each normalized feature and generating an object data set; and generating an anonymous object identifier from the object data set.

### PRIORITY PATENT APPLICATION

This non-provisional patent application claims priority to U.S. provisional patent application, Ser. No. 61/649,346; filed on May 20, 2012 by the same applicant as the present patent application. The present patent application draws priority from the referenced provisional patent application. The entire disclosure of the referenced provisional patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2012, Transportation Security Enterprises, Inc. (TSE); All Rights Reserved.

### TECHNICAL FIELD

This patent application relates to a system and method for use with networked computer systems, real time data collection systems, and sensor systems, according to one embodiment, and more specifically, to a system and method for anonymous object identifier generation and usage for tracking.

### BACKGROUND

The inventor of the present application, armed with personal knowledge of violent extremist suicide bomber behaviors, determined that the “insider, lone wolf, suicide bomber” was the most difficult enemy to counter. The inventor, also armed with the history of mass transit passenger rail bombings by violent extremist bombers, determined that the soft target of mass transport was the most logical target. As such, the security of passengers or cargo utilizing various forms of mass transit has increasingly become of great concern worldwide. The fact that many high capacity passenger and/or cargo mass transit vehicles or mass transporters, such as, ships, subways, trains, trucks, buses, and aircraft, have been found to be “soft targets” have therefore increasingly become the targets of hostile or terrorist attacks. The problem is further exacerbated given that there are such diverse methods of mass transit within even more diverse environments. The problem is also complicated by the difficulty in providing a high bandwidth data connection with a mobile mass transit vehicle. Therefore, a very comprehensive and unified solution is required. For example, attempts to screen cargo and passengers prior to boarding have improved safety and security somewhat, but these solutions have been few, non-cohesive, and more passive than active. Conventional systems do not provide an active, truly viable real time solution that can effectively, continuously, and in real time monitor and report activity at a venue, trends in visitor and passenger behavior, and on-board status information for the duration of a vehicle in transit, and in response to adverse conditions detected, actively begin the mitigation process by immediately alerting appropriate parties and systems. Although there have been certain individual developments proposed in current systems regarding different individual aspects of the overall problem, no system has yet been developed to provide an active, comprehensive, fully-integrated real time system to deal with the entire range of issues and requirements involved within the security and diversity of mass transit. In particular, conventional systems do not provide the necessary early detection in real time, and potentially aid in the prevention of catastrophic events. Separate isolated systems that have difficulty aggregating information and are not in real time, nor aggregated against enough information to allow for a composite alert or pre-alert conclusion.

In many cases, it becomes necessary to collect biometric information related to particular individuals. However, the processing, retention, and distribution of this information can be highly problematic given the privacy rights of the individuals involved. Conventional systems have been unable to effectively solve this problem.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for real time data analysis;

FIG. 2 illustrates an example embodiment of the functional components of the real time data analysis system;

FIG. 3 illustrates an example embodiment of the functional components of the analysis tools module;

FIG. 4 illustrates an example embodiment of the functional components of the rule manager;

FIG. 5 illustrates an example embodiment of the functional components of the anonymous identifier processing module;

FIG. 6 illustrates an example embodiment of the processing performed to produce the anonymous object identifier;

FIG. 7 is a processing flow chart illustrating an example embodiment of a system and method for anonymous object identifier generation and usage for tracking as described herein;

FIG. 8 is a processing flow chart illustrating an example embodiment of a system and method for real time data analysis as described herein; and

FIG. 9 shows a diagrammatic representation of machine in the example form of as computer system within which a set of instructions when executed may cause the machine to perform any one or more of the methodologies disclosed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

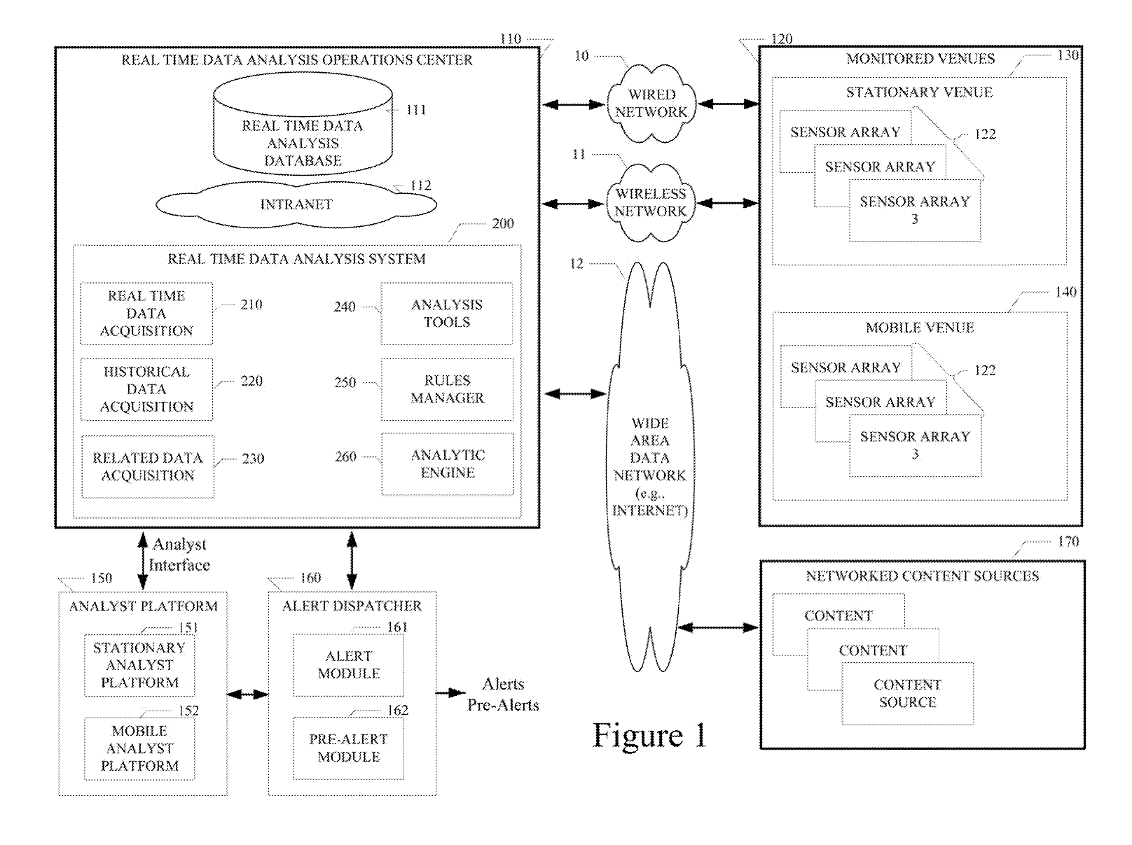

Referring to FIG. 1, in an example embodiment, a system and method for anonymous object identifier generation and usage for tracking are disclosed. In various example embodiments, a real time data analysis system 200, typically operating in or with a real time data analysis operations center 110, is provided to support the real time analysis of data captured from a variety of sensor arrays. A plurality of monitored venues 120, at which a plurality of sensor arrays 122 are deployed, are in network communication with the real time data analysis operations center 110 via a wired network 10 or a wireless network 11. As described in more detail below, the monitored venues 120 can be stationary venues 130 and/or mobile venues 140. The sensor arrays 122 can be virtually any form of data or image gathering and transmitting, device. In one embodiment, a sensor of sensor arrays 122 can include a standard surveillance video camera or other device for capturing biometrics. The term, ‘biometrics’ refers to unique physiological and/or behavioral characteristics of a person that can be measured or identified. Example characteristics include height, weight, fingerprints, retina patterns, skin and hair color, feature characteristics, voice patterns, and any other measurable metrics associated with an individual person. Identification systems that use biometrics are becoming, increasingly important security tools. Identification systems that recognize irises, voices or fingerprints have been developed and are in use. These systems provide highly reliable identification, but require special equipment to read the intended biometric (e.g., fingerprint pad, eye scanner, etc.) Because of the expense and inconvenience of providing special equipment for gathering these types of biometric data, facial recognition systems requiring only as simple video camera for capturing an image of as face have also been developed. In terms of equipment costs and user-friendliness. Facial recognition systems provide many advantages that other biometric identification systems cannot. For instance, face recognition does not require direct contact with a user and is achievable from relatively far distances, unlike most other types of biometric techniques, e.g., fingerprint and retina scans. In addition. face recognition may be combined with other image identification methods that use the same input images. For example, height and weight estimation based on comparison to known reference objects within the visual field may use the same image as face recognition, thereby providing more identification data without any extra equipment. The use of facial imaging for identification in an example embodiment is described in more detail below.

In other embodiments, sensor arrays 122 can include motion detectors, magnetic anomaly detectors, metal detectors, audio capture devices, infrared image capture devices, and/or a variety of other of data or image gathering and transmitting, devices. Sensor arrays 122 can also include video cameras mounted on a mobile host. in a particularly novel embodiment, a video camera of sensor arrays 122 can be fitted to an animal. For example, camera-enabled head gear can be fitted to a substance-sensing canine deployed in a monitored venue. Such canines can be trained to detect and signal the presence of substances of interest (e.g., explosive material, incendiaries, narcotics, etc.) in a monitored venue. By virtue of the canine's skill in detecting these materials and the camera-enabled head gear fitted to them, these mobile hosts can effectively place a video camera in close proximity to sources of these substances of interest. For example, on a crowded subway platform, a substance-sensing canine can isolate a particular individual among the crowd and place a video camera directly in front of the individual. In this manner, the isolated individual can be quickly and accurately identified, logged, and tracked using facial recognition technology. Conventional systems have no such capability to isolate a suspect individual and capture the suspect's biometrics at a central operations center.

Referring still to FIG. 1, real time data analysis operations center 110 of an example embodiment is shown to include a real time data analysis system 200, intranet 112, and real time data analysis database 111. Real time data analysis system 200 includes real time data acquisition module 210, historical data acquisition module 220, related data acquisition module 230, analysis tools module 240, rules manager module 250, and analytic engine 260. Each of these modules can be implemented as software components executing within an executable environment of real time data analysis system 200 operating at or with real time data analysis operations center 110. These modules can also be implemented in whole or in part as hardware components for processing signals and data for the environment of real time data analysis system 200. Each of these modules of an example embodiment is described in more detail below in connection with the figures provided herein.

An example embodiment can take multiple and diverse, sensor input from sensor arrays 122 at the monitored venues 120 and produce sensor data streams that can be transferred across wired network 10 and/or wireless network 11 to real time data analysis operations center 110 in near real time, in an alternative embodiment, the sensor data streams can be retained in as front-end data collector or data center, which can be accessed by the operations center 110. The real time data analysis operations center 110 and the real time data analysis system 200 therein acquires, extracts, and retains the information embodied in the sensor data streams within a privileged database Ill of operations center 110 using real time data acquisition module 210. For the stationary venues 130, wired networks 10 and/or wireless networks 11 can be used to transfer the current sensor data streams to the operations center 110. Given the deployment of the sensor arrays 122 and the multiple video feeds that can result, a significant quantity of data may need to he transferred across wired networks 10 and/or wireless networks 11. Nevertheless, the appropriate resources can be deployed to support the data transfer bandwidth requirements. However, supporting the mobile venues 140 can be more challenging. The mobile venues 140 can include mass transit vehicles, such as trains, ships, ferries, buses, aircraft, automobiles, trucks, and the like. The embodiments disclosed herein include a broadband wireless data transceiver capable of high data rates to support the wireless transfer of the current sensor data streams to the operations center 110. As such, the wireless networks 11, including a high-capacity broadband wireless data transceiver, can be used to transfer the current sensor data streams from mobile venues 140 to the operations center 110. In some cases, the mobile venues 140 can include a wired data transfer capability. For example, some train or subway systems include fiber, optical, or electrical data transmission lines embedded in the railway tracks existing rail lines. These data transmission lines can also be used to transfer the current sensor data streams to the operations center 110. As such, the wired networks 10, including embedded data transmission lines, can also be used to transfer the current sensor data streams from mobile venues 140 to the operations center 110.

In real time, the acquired sensor data streams can be analyzed by the analysis tools module 240, rules manager module 250, and analytic engine 260. The acquired real time sensor data streams are correlated with corresponding historical data streams obtained from the sensor arrays 122 in prior time periods and corresponding related data streams obtained from other data sources, such as network-accessible databases (e.g., motor vehicle licensing databases, criminal registry databases, intelligence databases, etc.), The historical data streams are acquired, retained, and managed by the historical data acquisition module 220. The related, data streams are acquired, retained, and managed by the related data acquisition module 230. In some cases, the network-accessible databases providing sources for the related data streams can be accessed using a wide-area data network such as the internet 12. In other cases, secure networks can be used to access the network-accessible databases. As described in more detail below, components within the real time data analysis system 200 can analyze aggregate, and cross-correlate the acquired real time sensor data streams, the historical data streams, and the related data streams to identify threads of activity, behavior, and/or status present or occurring in a monitored venue 120. In this manner, patterns or trends of activity, behavior, and/or status can be identified and tracked. Over time, these patterns can be captured and retained in database 111 as historical data streams by the historical data acquisition module 220. In many cases, these patterns represent nominal patterns of activity, behavior, and/or status that pose no threat. In other cases, particular patterns of activity, behavior, and/or status can be indicative or predictive of hostile, dangerous, illegal, or objectionable behavior or events.

The various embodiments described herein can isolate and identify these potentially threating patterns of activity, behavior, and/or status and issue alerts or pre-alerts in advance of undesirable conduct. In some cases, a potentially threating pattern can be identified based on an analysis of as corresponding historical data stream. For example, a particular individual present in a particular monitored venue 120 can be identified using the real time data acquired from the sensor arrays 177 and the facial recognition techniques described above, This individual can be assigned a unique identity by the real time data analysis system 200 to both record and track the individual within the system 200 and to protect the privacy of the individual. The method for generating and using the unique identity (e.g., the anonymous object identifier or the biometric-based anonymous personal identifier) is described in more detail below. Using the real time data acquired from the sensor arrays 122, the behavior of the identified individual can be tracked and time-stamped in a thread of behavior as the individual moves through the monitored venue 120. In a subsequent time period (e.g., the following day), the same individual may be identified in the same monitored venue 120 using the facial recognition techniques. Given the facial recognition data, the unique identity assigned to the individual in a previous time period can be correlated to the same individual in the current time period. Similarly, the thread of behavior corresponding to the individual's identity in a previous time period can be correlated to the individual's thread of behavior in the current time period. In this manner, the behavior of a particular individual can be compared with the historical behavior of the same individual from a previous time period. This comparison between current behaviors, activity, or status with historical behaviors, activity, or status from a previous time period may reveal particular patterns or deviations of activity, behavior, and/or status that can be indicative or predictive of hostile, dangerous, illegal, or objectionable behavior or events. For example, an individual acting differently today compared with consistent behavior in the prior month may be indicative of imminent conduct.

In a similar manner, the individual's current and/or historical behaviors at a first monitored venue can be compared with the individual's current and/or historical behaviors at a second monitored venue. In some cases, the threads of behavior at one venue may be indicative of behavior or conduct at a different venue. Thus, the various embodiments described herein can identify and track these threads of behaviors, activities, and/or status across various monitored venues and across different time periods.

Additionally, the various embodiments described herein can also acquire and use related data to further qualify and enhance the analysis of the real time data received from the sensor arrays 122. In an example embodiment, the related data can include related data streams obtained from other data sources, such as network-accessible databases (e.g., motor vehicle licensing databases, criminal registry databases, intelligence databases, etc.). The related data can also include data retrieved from local databases. In general, the related data streams provide an additional information source, which can be correlated to the information extracted from the real time data streams. For example, the analysis of the real time data stream from the sensor arrays 122 of a monitored venue 120 may be used to identify a particular individual present in the particular monitored venue 120 using the facial recognition techniques described above. Absent any related data, it may be difficult to determine if the identified individual poses any particular threat. However, the real time data analysis system 200 of an example embodiment can acquire related data from a network-accessible data source, such as content sources 170. The facial recognition data extracted from the real time data stream or the anonymous object identifier generated from the data stream can be used to index a database of a network-accessible content source 170 to obtain data related to the identified individual. For example, the extracted facial recognition data can be used to locate and acquire driver license information corresponding to the identified individual from a motor vehicle licensing database. Similarly, the extracted facial recognition data can be used to locate and acquire criminal arrest warrant information corresponding to the identified individual from as criminal registry database. It will be apparent to those of ordinary skill in the art that a variety of information related to an identified individual can be acquired from a variety of network-accessible content sources 170 using the real time data analysis system 200 of an example embodiment.

The various embodiments described herein can use the current real time data streams, the historical data streams, and related data streams to isolate and identify potentially threating patterns of activity, behavior, and/or status in a monitored venue and issue alerts or pre-alerts in advance of undesirable conduct. In real time, the acquired sensor data streams can be analyzed by the analysis tools module 240, rules manager module 250, and analytic engine 260. Analysis tools module 240 includes a variety of functional components for parsing, filtering, sequencing, synchronizing, prioritizing, and marshaling the current data streams, the historical data streams, and the related data streams for efficient processing by the analytic engine 260. The rules manager module 250 embodies sets of rules, conditions, threshold parameters, and the like, which can be used to define thresholds of activity, behavior, and/or status that should trigger a corresponding alert, pre-alert, and/or action. For example, a rule can be defined that specifies that: 1) when an individual enters a monitored venue 120 and is identified by facial recognition, and 2) the same individual is matched to an arrest warrant using a related data stream, then 3) an alert should be automatically issued to the appropriate authorities. A variety of rules having a construct such as, “IF <Condition> THEN <Action>” can be generated and managed by the rules manager module 250. Additionally, an example embodiment includes an automatic rule generation capability, which can automatically generate rules given desired outcomes and the conditions by which those desired outcomes are most likely. In this manner, the embodiments described herein can implement machine learning processes to improve the operation of the system over time. Moreover, an embodiment can include information indicative of a confidence level corresponding to a probability level associated with a particular condition and/or need for action.

The analytic engine 260 can cross-correlate the current data streams, the historical data streams, and the related data streams to detect patterns, trends, and deviations therefrom. The analytic engine 260 can detect normal and non-normal activity, behavior, and/or status and activity, behavior, and/or status that is consistent or inconsistent with known patterns of concern using cross-correlation between data streams and/or rules-based analysis. As a result, information can be passed by the real time data analysis system 200 to an analyst interface provided for data communication with the analyst platform 150.

The analyst platform 150 represents a stationary analyst platform 151 or a mobile analyst platform 152 at which as human analyst can monitor the analysis information presented by the real time data analysis system 200 and issue alerts or pre-alerts via the alert dispatcher 160. An alert can represent a rules violation. A pre-alert can represent the anticipation of an event. The analyst platform 150 can include a computing platform with a data communication and information display capability. The mobile analyst platform 152 can provide a similar capability in a mobile platform, such as a truck or van. Wireless data communications can be provided to link the mobile analyst platform 152 with the operations center 110. The analyst interface is provided to enable data communication with analyst platform 150 as implemented in a variety of different configurations.

The alert dispatcher 160 represents a variety of communications channels by which alerts or pre-alerts can be transmitted. These communication channels can include electronic alerts, alarms, automatic telephone calls or pages, automatic emails or text messages, or a variety of other modes of communication. In one embodiment, the alert dispatcher 160 is connected directly to real time data analysis system 200. In this configuration, alerts or pre-alerts can be automatically issued based on the analysis of the data streams without involvement by the human analyst. In this manner, the various embodiments can quickly, efficiently, and in real time respond to activity, behavior, and/or status events occurring in a monitored venue 120.

Networks 10, 11, 12, and 112 are configured to couple one computing device with another computing device. Networks 10, 11, 12, and 112 may be enabled to employ any limn of computer readable media for communicating information from one electronic device to another. Network 10 can be a conventional form of wired network using conventional network protocols. Network 11 can be a conventional form of wireless network using conventional network protocols. Proprietary data sent on networks 10, 11, 12, and 112 can be protected using conventional encryption technologies.

Network 12 can include a public packet-switched network. such as the Internet, wide area networks (WANs), direct connections, such as through a universal serial bus (USB) port, other forms of computer-readable media, or any combination thereof. On an interconnected set of LANs, including those based on differing architectures and protocols, a router or gateway acts as a link between LANs, enabling messages to be sent between computing devices. Also, communication links within LANs typically include twisted wire pair or coaxial cable links, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art.

Network II may further include any of a variety of wireless nodes or sub-networks that may further overlay stand-alone ad-hoc networks, and the like, to provide an infrastructure-oriented connection. Such sub-networks may include mesh networks, Wireless LAN (WLAN) networks, cellular networks, and the like. Network 11 may also include an autonomous system of terminals, gateways, routers, and the like connected by wireless radio links or wireless transceivers. These connectors may be configured to move freely and randomly and organize themselves arbitrarily, such that the topology of network 11 may change rapidly.

Network 11 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more client devices with various degrees of mobility. For example, network 11 may enable a radio connection through a radio network access such as Global System liar Mobile communication (GSM), General Packet Radio Services (GPRS), Enhanced Data GSM Environment (EDGE), Wideband Code Division Multiple Access (WCDMA), CDMA2000, and the like.

Network 10 may include any of a variety of nodes interconnected via a wired network connection. Such wired network connection may include electrically conductive wiring, coaxial cable, optical fiber, or the like. Typically, wired networks can support higher bandwidth data transfer than similarly configured wireless networks. For legacy network support, remote computers and other related electronic devices can be remotely connected to either LANs or WANs via a modem and temporary telephone link.

Networks 10, 11, 12, and 112 may also be constructed for use with various other wired and wireless communication protocols, including TCP/IP, UDP, SIP, SMS, RTP, WAP, CDMA, TDMA, EDGE, UMTS, GPRS, GSM, UW13, WiMax, IEEE 802.11x, WiFi, Bluetooth, and the like. In essence, networks 10, 11, 12, and 112 may include virtually any wired and/or wireless communication mechanisms by which information may travel between one computing device and another computing device, network, and the like. In one embodiment, network 112 may represent a LAN that is configured behind a firewall (not shown), within a business data center, for example.

The content sources 170 may include any of a variety of providers of network transportable digital content. This digital content can include a variety of content related to the monitored venues 120 and/or individuals or events being monitored within the monitored venue 120. The networked content is often available in the limn of a network transportable digital file or document. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3-MP3, and the like), video (e.g., MP4, and the like), and any proprietary interchange format defined by specific content sites can be supported by the various embodiments described herein.

In a particular embodiment, the analyst platform 150 and the alert dispatcher 160 can include a computing platform with one or more client devices enabling an analyst to access information from operations center 110 via an analyst interface. The analyst interface is provided to enable data communication between the operations center 110 and the analyst platform 150 as implemented in a variety of different configurations. These client devices may include virtually any computing device that is configured to send and receive information over to network or a direct data connection. The client devices may include computing devices, such as personal computers (PCs), multiprocessor systems, microprocessor-based or programmable consumer electronics, network PC's, and the like. Such client devices may also include mobile computers, portable devices, such as, cellular telephones, smart phones, display pagers, radio frequency (RF) devices, infrared (IR) devices, global positioning devices (GPS). Personal Digital Assistants (PDAs), handheld computers, wearable computers, tablet computers, integrated devices combining one or more of the preceding devices, and the like. As such, the client devices may range widely in terms of capabilities and features. For example, a client device configured as a cell phone may have a numeric keypad and a few lines of monochrome LCD display on which only text may be displayed. In another example, a web-enabled client device may have a touch Sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission or a direct data connection. The client application may include a capability to provide and receive textual content, graphical content, video content, audio content, alerts, messages, notifications, and the like. Moreover, client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. Client devices may also include a wireless application device on which a client application is configured to enable a user of the device to send and receive information to/from network sources wirelessly via a network.

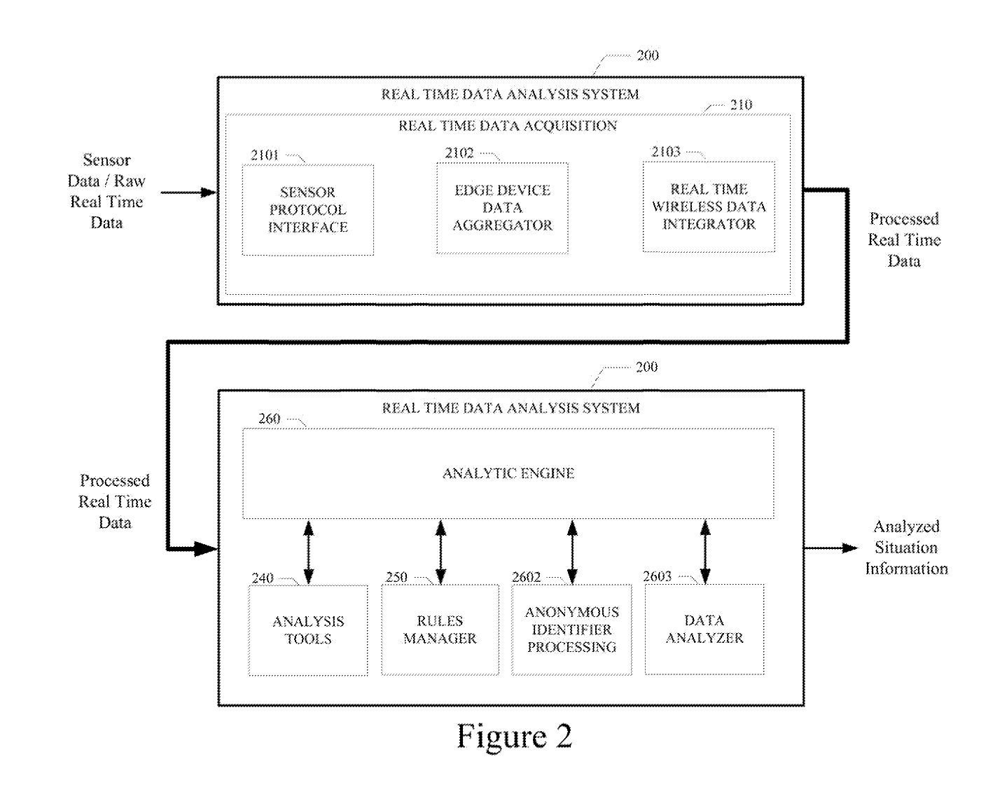

Referring now to FIG. 2, a system diagram illustrates the functional components of the real time data analysis system 200 of an example embodiment. As shown, the real time data analysis system 200 includes a real time data acquisition module 210 and analytic engine 260. The real time data analysis system 200 uses real time data acquisition module 210 to acquire, extract, and retain the information embodied in the sensor data streams within a privileged database 111 of operations center 110. The real time data analysis system 200 uses analytic engine 260 to extract information from the real time data in the acquired sensor data streams. FIG. 2 illustrates the flow and processing of data from the raw sensor data streams through the real time data acquisition module 210 and then through the analytic engine 260. As a result, raw real time sensor data is processed into useful analyzed situation information that can be used by an analyst at the analyst platform 150 to assess activity and potential threats at a monitored venue 120 and take appropriate action.

Referring still to FIG. 2, the real time data acquisition module 210 of an example embodiment is shown to include a sensor protocol interface 2101, an edge device data aggregator 2102, and a real time wireless data integrator 2103. The sensor protocol interface 2101 provides a processing engine for converting data from a variety of different sensing devices into a uniform sensor data interface. Because the sensor arrays 122 in a particular monitored venue 120 can include a wide variety of different sensors, possibly manufactured by different manufacturers, the sensor data provided by the sensor arrays 122 can be a highly heterogeneous data set. For example, the data provided by a metal detector is not the same type of data and is typically formatted differently than the data provided by a temperature sensor. Similarly, video stream data from two video cameras manufactured by two different camera manufacturers can be in completely different formats. The sensor protocol interface 2101 can convert these heterogeneous sensor data sets into homogeneous sensor data sets with consistent formats and data structures, which can be more easily and quickly processed by downstream data processing modules.

The edge device data aggregator 2102 is a collector of raw data feeds from video cameras, sensors, and telemetry units. In one embodiment, the edge device data aggregator 2102 can receive a portion of the raw data feeds via the sensor protocol interface 2101. The edge device data aggregator 2102 can receive raw video feeds from a plurality of video cameras positioned at various locations in a monitored venue 120. Similarly, the edge device data aggregator 2102 can receive raw sensor data from a plurality of sensors positioned at various locations in a monitored venue 120. Examples of the various types of sensors in an example embodiment are listed below. Additionally, the edge device data aggregator 2102 can receive telemetry data generated at the monitored. venue 120. The telemetry data can include, for example, speed/rate. GPS (global positioning system) location, engine status, brake status, control system status, track status, and a variety of other data. in one embodiment, the edge device data aggregator 2102 can be installed at or proximately to the monitored venue 120. For example, the monitored venue 120 might be a railcar of a subway train. The railcar can be fitted with a set of video cameras and a variety of sensors. Additionally, the railcar can be fitted with a telemetry unit to gather the telemetry data related to the movement and status of the railcar and the track on which the railcar rides. The variety of sensors can include sensors for detecting any of the fallowing conditions: temperature, radiologicals, nuclear materials, chemicals, biologicals, explosives, microwaves, biometrics, active infrared (IR), capacitance, vibration, fiber optics, glass breakage, network intrusion detection (NIDS), human intrusion detection (HIDS), radio frequency identification (RFID), wireless MAC addresses, motion detectors, magnetic anomaly detectors, metal detectors, pressure, audio, and the like. In one embodiment, the railcar can also be fitted with the edge device data aggregator 2102. Each of the data feeds from the set of video cameras, the set of sensors, and the telemetry device on the railcar can be connected to the edge device data aggregator 2102 directly or via the sensor protocol interface 2101. In most cases, these data feeds can be connected to the edge device data aggregator 2102 via wired connections or wirelessly using conventional WiFi or Bluetooth close proximity wireless technology. In this manner, the edge device data aggregator 2102 can receive a plurality of data feeds from a plurality of sensor arrays 122 at a particular monitored venue 120

Once the edge device data aggregator 2102 has received the data feeds from the various sensor arrays 122, the edge device data aggregator 2102 can perform a variety of processing operations on the raw sensor data. In one embodiment, the edge device data aggregator 2102 can simply marshal the raw sensor data and send the combined, sensor data to the real time wireless data integrator 2103. The real time wireless data integrator 210$ can use wireless and wired data connections to transfer the sensor data to the analytic engine 260 as described in more detail below. In another embodiment, the edge device data aggregator 2102 can perform several data processing operations on the raw sensor data. For example, the edge device data aggregator 2102 can stamp (e.g., add meta data to) the data set from each sensor with the time/date and geo-location corresponding to the time and location when/where the data was captured. This time and location information can be used by downstream processing systems to synchronize the data feeds from the sensor arrays 122. Additionally, the edge device data aggregator 2102 can perform other processing operations on the raw sensor data, such as, data filtering, data compression, data encryption, error correction, local backup, and the like. In one embodiment, the edge device data aggregator 2102 can also be configured to perform the same image analysis processing locally at the monitored venue 120 as would be performed by the analytic engine 260 as described in detail below. Alternatively, the edge device data aggregator 2107 can be configured to perform a subset of the image analysis processing as would he performed by the analytic engine 260. In this manner, the edge device data aggregator 2102 can act as a local (monitored venue resident) analytic engine for processing the sensor data without transferring the sensor data back to the operations center 110. This capability is useful if communications to the operations center 110 is lost for a period of time. Using any of the embodiments described herein, the edge device data aggregator 2102 can process the raw sensor data and send the processed real time sensor data (including video and telemetry data) to the real time wireless data integrator 2103.

The real time wireless data integrator 2103 can receive the processed real time data from the edge device data aggregator 2102 as a broadband wireless data signal. A wireless transceiver in the edge device data aggregator 2102 is configured to communicate wirelessly with one of a plurality of wireless transceivers provided as part of a wireless network enabled by the real time wireless data integrator 2103. The plurality of wireless transceivers of the real time wireless data integrator 2103 network can be positioned at various geographical locations within or adjacent to a monitored venue 120 to provide continuous wireless data coverage for a particular region in or near a monitored venue 120. For example, a plurality of wireless transceivers of the real time wireless data integrator 2103 network can be positioned along a rail or subway track and at a rail or subway station to provide wireless data connectivity for a railcar or subway train operating on the track. In this example, the wireless transceiver in the edge device data aggregator 2102 located in the railcar is configured to communicate wirelessly with one of a plurality of wireless transceivers of the real time wireless data integrator 2103 network positioned along the track on which the railcar is operating. As the railcar moves down the track, the railcar moves through the coverage area for each of the plurality of wireless transceivers of the real time wireless data integrator 2103 network. Thus, the wireless transceiver in the edge device data aggregator 2102 can remain in constant network connectivity with the real time wireless data integrator 2103 network. Given this network connectivity, the real time wireless data integrator 2103 can receive the processed real time data from the edge device data aggregator 2102 at very high data rates.

Referring still to FIG. 2, having received the processed real time data from the monitored venue 120 as described above, the real time wireless data integrator 2103 can use wireless and/or wired network data connections to transfer the processed real time data to the analytic engine 260 at the operations center 110 via wired networks 10 and/or wireless networks 11. In some cases, the real time wireless data integrator 2103 can use a wired data transfer capability to transfer the processed real time data to the analytic engine 260. For example, some train or subway systems include fiber, optical, or electrical data transmission lines embedded in the railway tracks of existing rail lines. These embedded data communication lines can be used to transfer the processed real time data to the analytic engine 260.

In one embodiment, the processed real time data is transferred from the real time wireless data integrator 2103 to a set of front end data collectors. These data collectors can act as data centers or store-and-forward data repositories from which the analytic engine 260 can retrieve data according to the analytic engine's 260 own schedule. In this manner, the processed real time data can be retained and published to the analytic engine 260 and to other client applications, such as command/control applications or applications operating at the monitored venue 120. The analytic engine 260 and the client applications can access the published processed real time data via a secure network connection.

Referring still to FIG. 2, the analytic engine 260 receives the processed real time data via the real time data acquisition system 210 as described above. The analytic engine 260 can also receive the historical data streams and related data streams as described above. The analytic engine 260 is responsible for processing these data streams, including the real time data received from the sensor arrays 122. As shown in FIG. 2, the acquired data streams can be analyzed by the analysis tools module 240, the rules manager module 250, the anonymous identifier processing module 2602, and the data analyzer 2603 of the analytic engine 260. These components of the analytic engine 260 are described in more detail below.

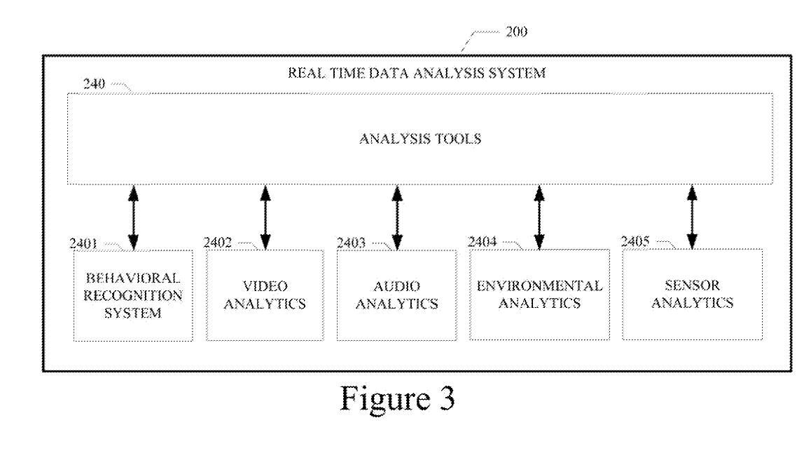

The analysis tools module 240, of an example embodiment, includes a variety of functional components for parsing, filtering, sequencing, synchronizing, prioritizing, analyzing, and marshaling the real time data streams, the historical data streams, and the related data streams for efficient processing by the other components of the analytic engine 260. The details of an example embodiment of the analysis tools module 240 are shown in FIG. 3.

Referring now to FIG. 3, details of an example embodiment of the analysis tools module 240 are shown. In the example embodiment, the analysis tools module 240 is shown to include a behavioral recognition system 2401, a video analytics module 2402, an audio analytics module 2.403, an environmental analytics module 2404, and a sensor analytics module 2405. The behavioral recognition system 2401 is used for analyzing and learning the behavior of objects (e.g., people) in a monitored venue 120 based on an acquired real time data stream. In one embodiment, objects depicted in the real time data stream (e.g., a video stream) can be identified based on an analysis of the frames in the video stream. Each object may have as corresponding behavior model used to track an object's motion frame-to-frame. In this manner, an object's behavior over time in the monitored venue 120 can be analyzed. One such behavioral recognition system is described in U.S. Pat. No. 8,131,012. The behavioral analysis information gathered or generated by the behavioral recognition system 2401 can be received by the analysis tools module 240 and provided to the analytic engine 260. The video analytics module 2402 can be used to perform a variety of processing operations on a real time video stream received from a monitored venue 120. These processing operations can include: video image filtering, color or intensity adjustments, resolution or pixel density adjustments, video frame analysis, object extraction, object tracking, pattern matching, object integration, rotation, zooming, cropping, and a variety of other operations for processing a video frame. The video analysis data gathered or generated by the video analytics module 2402 can be provided to the analytic engine 260. The audio analytics module 2403 can be used to perform a variety of audio processing operations on a real time video or audio stream received from a monitored venue 120. These processing operations can include: audio filtering, frequency analysis, audio signature matching, ambient noise suppression, and the like. The audio analysis data gathered or generated by the audio analytics module 2403 can be provided to the analytic engine 260. The environmental analytics module 2404 can be used to gather and process various environmental parameters received from various sensors at the monitored venue 120, For example, temperature, pressure, humidity, lighting level, and other environmental data can be collected and used to infer environmental conditions at a particular monitored venue 120. This environmental data gathered or generated by the environmental analytics module 2404 can be provided to the analytic engine 260. The sensor analytics module 2405 can be used to gather and process various other sensor parameters received from various sensors at the monitored venue 120. This sensor data gathered or generated by the sensor analytics module 2405 can be provided to the analytic engine 260.

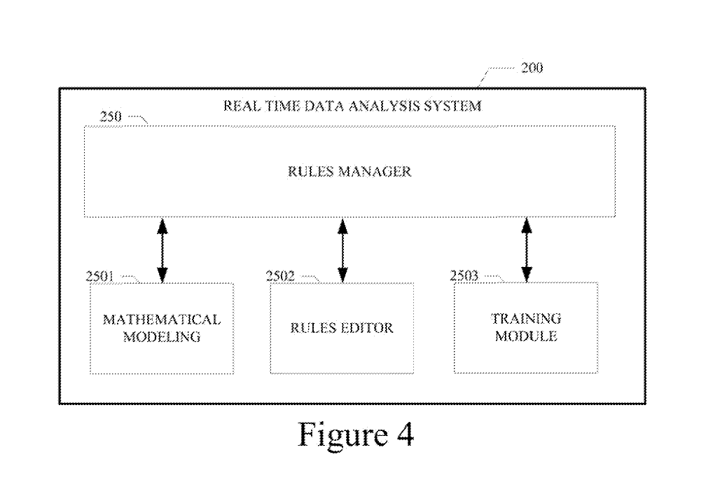

Referring now to FIG. 4, an example embodiment of the components of the rule manager 250 is illustrated. As described above, the rules manager module 250 embodies sets of rules, conditions, threshold parameters, and the like, which can be used to define thresholds of activity, behavior, and/or status that should trigger a corresponding alert, pre-alert, and/or action. In an example embodiment, the rules manager 250 includes a mathematical modeling module 2501, a rules editor 2502, and a training module 2503. The mathematical modeling module 2501 provides the decision logic for implementing sets of rules that define actions to be triggered based on a set of conditions. For example, a variety of rules having to construct such as, “IF <Condition> THEN <Action>” can be generated and managed by the rules editor 2502. In an example embodiment, the rules manager 250 provides an automatic rule generation capability, which can automatically generate rules given desired outcomes and the conditions by which those desired outcomes are most likely. In this manner, the embodiments described herein can implement machine learning processes to improve the operation of the system over time. The training module 2503 can be used to train and configure these machine learning processes.

Anonymous Object Identifier Generation and Usage for Tracking

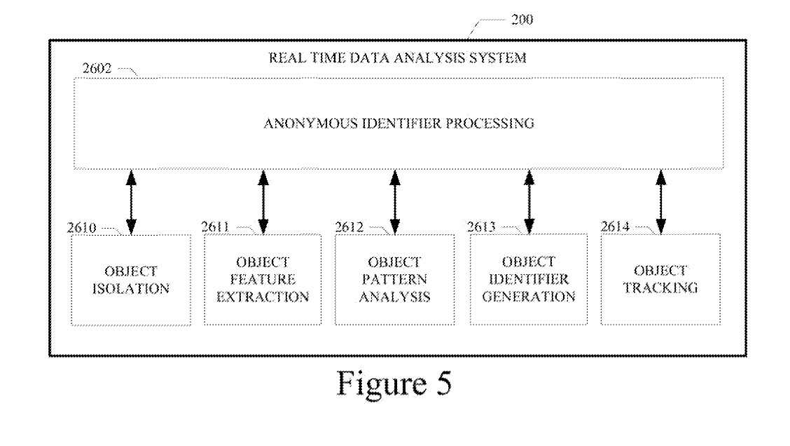

Referring now to FIG. 5, the functional components of the anonymous identifier processing module 2602 of an example embodiment are illustrated. In general, the anonymous identifier processing module 2602 receives an image data stream from the real time data acquisition module 210. This image data stream can be sourced, for example, from a video camera of the sensor array 122 at a monitored venue 120. The image data stream can also be sourced from historical/archived video streams, individual video frames, still image photos, conventional photographs, screen grabs, scanned or faxed images, and any other source of motion or still images. As described in more detail below, the anonymous identifier processing module 2602 performs a variety of processing operations on this input image data stream to identify and extract features of an object of interest from the input image, generate an object data set from the extracted features, and then generate an anonymous object identifier from the object data set.

The anonymous object identifier represents a unique and deterministic identifier, code, or tag that corresponds to the particular visual characteristics of the object of interest. In many cases, the object of interest can be a human face appearing in the image data stream. In this case, the visual features of the face are used to generate the anonymous object identifier. The facial features correspond to the biometric characteristics of the individual appearing in the image data stream. As such these biometric characteristics care personal to the individual in the image. Therefore, when the object of interest is a human face or a human form, the anonymous object identifier can be denoted as a biometric-based anonymous personal identifier. Importantly, the anonymous object identifier can be generated strictly from the image data and without any information related to the personal identity of the imaged individual. Thus, the biometric-based personal identifier as described herein is anonymous, because no personal identity or other private information of the imaged individual needs to be connected to the anonymous object identifier. It is also important to note that the anonymous object identifier as described herein can be generated from and relative to objects of interest that are not human faces or human forms. For example, non-human objects of interest appearing in an input image data stream can include vehicles, weapons, carried items (e.g., backpacks, briefcases, handbags, etc.), and the like. These nonhuman objects of interest also have visual features, which can be extracted and used to generate the anonymous object identifier as described herein. Thus, the anonymous identifier processing, module 2602 of an example embodiment can process an image data stream to generate one or more anonymous object identifiers, each corresponding to an object of interest appearing in the input image data stream. Because the anonymous object identifiers correspond to the particular visual characteristics of the object of interest, it is highly likely that the same anonymous object identifier value will be generated for the same object of interest, even when the object of interest appears in different video frames, in different video feeds, in different monitored venues, or in different time periods. Thus, the anonymous object identifier provides an effective way of identifying and tracking the same object of interest over various times and locations. In the description that follows, the details of an example embodiment of the anonymous identifier processing module 2602 are provided.

Referring still to FIG. 5, the anonymous identifier processing module 2602 of an example embodiment includes an object isolation module 2610, an object feature extraction module 2611, an object pattern analysis module 2612, an object identifier generation module 2613, and an object tracking module 2614. As described in more detail below, these modules perform various processing operations on an input image data stream, the operations including: obtaining a frame from one of a plurality of data streams received from a plurality of sensor arrays deployed at a monitored venue; isolating, a region surrounding an object of interest in the frame; performing feature extraction on the object of interest in the region; identifying patterns from the extracted features; normalizing the extracted features based on the identified patterns; quantifying each normalized feature and generating an object data set; and generating an anonymous object identifier from the object data set.

The object isolation module 2610 receives an input image data stream and iteratively operates on image frames of the input image data stream. In one embodiment, each frame of the input image data stream is processed. In other embodiments, particular frames are selected for processing based on available processing capacity, a level of activity in the scene represented by the input data stream, or other configurable parameters. Then, for each frame, an object detection and isolation process is performed on the frame.

In an example embodiment, an image based object detection method can be used. For example, “Viola, P. and M. Jones (2001), Rapid object detection using a boosted cascade of simple features, Proceedings of the 2001 IEEE Computer Society Conference on Computer Vision and Pattern Recognition, 2001, CVPR 2001”, incorporated herein by reference, discloses a method for good object detection performance in real-time. A particular implementation of this method combines weak classifiers based on simple binary features, operating on sub-windows, which can be computed very quickly. These sub-windows of the input image can be used to isolate a. region surrounding an object of interest in the frame. Simple rectangular Haar-like features are extracted; face and non-face classification is performed using a cascade of successively more complex classifiers, which discards non-face regions and only sends face-like object candidates to the next layer's classifier for further processing. Each layer's classifier can be trained by a learning algorithm. As presently applied, the cascaded face detector can find the location of a human face in an input image and mark or identify major facial features. A face training database can be used, which preferably includes a large number of sample face images taken under various lighting conditions, facial expressions and pose angle presentations. Negative training data images can also be randomly collected, which do not contain human faces. In a similar manner, non-facial objects can be identified and isolated in the input data stream. Once the facial objects and/or non-facial objects are identified in the input data stream by the object isolation module 2610, the object feature extraction module 2611 extracts the features of each of the identified objects.

In the case of a facial object, facial feature extraction can be performed, in a particular example embodiment, using a method of “Cootes, T. F., C. J. Taylor, et al. (1995), Active Shape Models Their Training and Application, Computer Vision and Image Understanding 61(1): 38-59”, incorporated herein by reference. Active Shape Models (ASM) provide a tool to describe deformable object images. Given a collection of training images for a certain object class where the feature points have been marked, a shape can be represented by processing the sample shape distributions as:

X=X+Φb

where X is the mean shape vector, Φ is the set of covariance matrices describing the shape variations learned from the training sets, and his a vector of shape parameters. Fitting the features of a given input face image to one or more statistical models of face features is an iterative process, where each facial feature point of the input image can be identified and adjusted by searching for a best-fit neighboring point corresponding to as feature point of the statistical models. In this manner, facial features can be identified and data corresponding to each identified facial feature can be extracted by the object feature extraction module 2611. Similarly, features of a given input non-face image can be compared to one or more statistical models of object features in an iterative process. Each object feature point of the input image can be identified and adjusted by searching for as best-lit neighboring point corresponding to a feature point of the statistical models. Using the technique described above, object features and the data sets describing each of these features can be extracted from the input data stream.

Once the features of a particular object are extracted by the object feature extraction module 2611, the object pattern analysis module 2612 can be used to identify patterns among and between the identified object features. For example, a dark oval feature identified in the input data stream may be difficult to initially classify. However, if the dark oval feature is located in the image proximately to another dark oval feature, the pattern thus created can be more readily identified as a pair of eyes in as face object. Similarly, other patterns can be detected based on the shape, location, and/or orientation of each of the features relative to each other and relative to a defined axis of orientation, A cascade of classifiers and statistical models of facial patterns can be used to identify these patterns. For example, for a face object, eye features can be identified relative to a nose feature, a cheekbone feature, and/or a mouth feature. Data corresponding to as plurality of object feature patterns can be recorded. This pattern data can include the shape, location, and/or orientation of each of the features in the pattern relative to each feature and relative to a defined axis of orientation. Thus, object feature patterns and the data sets describing each of these object feature patterns can be extracted from the input data stream. In this manner, object pattern identification can be performed using the described pattern analysis approach.

At this point in the process of an example embodiment, object features have been extracted from the input image data stream and feature patterns of the object have been identified. Given this object feature and pattern information, face classification and facial recognition operations can be performed. Similarly, other non-face object classification operations can be performed. However, the speed and accuracy of the classification and facial recognition operations can be improved if the feature data sets and pattern data for the object are normalized in a variety of ways.

Face normalization can be accomplished by performing face alignment and other processing operations. In one embodiment, face alignment can be performed using the following operations: after the eyes have been located in as face region. the coordinates (X_{left}, Y_{left}), (X_{right}, Y_{right}) of the eyes are used to calculate the rotation angle θ from a horizontal line. The face image can then be rotated to become a vertical frontal face image. In one embodiment, facial profiles in the input image can also be rotated to become a vertical frontal face image. Approximations of the facial objects in the frontal face image can be made based on the facial objects extracted from the profile image.

The object can be further processed according to the extracted facial or non-facial features and patterns using other normalization processing operations. By way of example only, these other processing operations may include: 1) converting grey scale values into floating point values; 2) using eye locations, cropping the image with an elliptical mask, which only removes the background from a face, and resealing the thee region; 3) equalizing the histogram of the masked face region; 4) normalizing the pixels inside of the face region so that the pixel values have a zero mean and a standard deviation of one; 5) adjusting for moving features; 6) performing color/shading normalization; 7) normalizing aspect ratio and pixel density; 8) and performing other well-known video or image processing techniques. in some embodiments, the input image data stream can include images captured with infrared or other types of conventional thermal imaging techniques. In these embodiments, the normalization processing operations can include the processing of thermal imaging used to illuminate Objects in dark environments (e.g., dark object in front of a dark background) or at night. As a result of these normalization processing operations, the normalized object data is more likely to match object data for the same object captured in a different image frame. It will be apparent to those of ordinary skill in the art that various normalization operations can be performed at any of the processing stages described above.

Given that each object identified and isolated from the input data stream can have multiple features, each object can have a plurality of associated object feature data sets and a plurality of object feature pattern data sets. An aggregation of the plurality of object feature data sets and object feature pattern data sets (denoted an object data set) for a particular object can be used to deterministically define the particular object. In other words, an object can be considered to be the sum of its feature and pattern parts (e.g., an aggregation of the object's feature data sets and object feature pattern data sets into an object data set). This aggregation into an object data set can be used to generate the anonymous object identifier as described in more detail below.

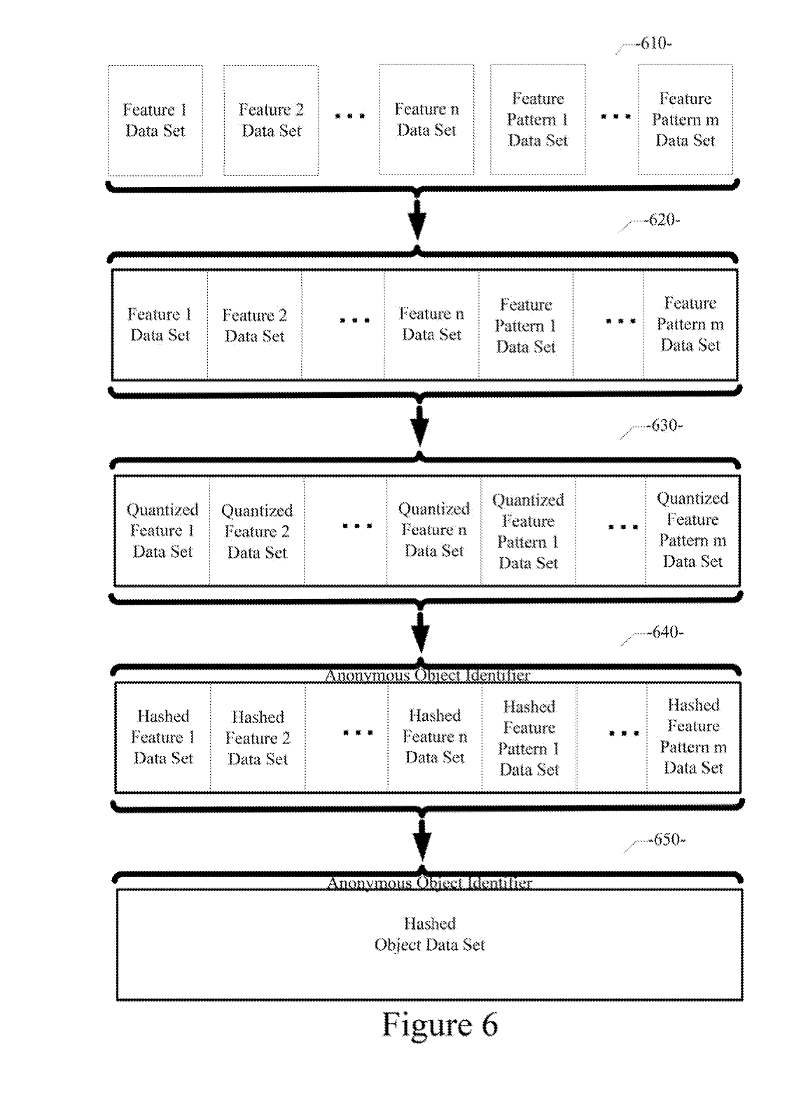

Once the plurality of object feature data sets and object feature pattern data sets for a particular object have been generated as described above, the object identifier generation module 2613 can be used to generate a unique anonymous object identifier corresponding to the object. Referring now to FIG. 6, a representation 610 of a set of object feature data sets and object feature pattern data sets for a particular object are shown. These data sets 610 can be generated in the manner as described above. The separately or independently generated data sets 610 can be aggregated or combined into a common data structure 620 as shown in FIG. 6. It will he apparent to those of ordinary skill in the art that additional data (not shown) can also be added to data structure 620 to more fully describe the object represented by the feature data and pattern data sets 620. For example, object meta data, descriptive data, timestamps, links, etc. can be added to data structure 620. In a next processing step, each of the elements of data structure 620 can be quantized as shown in FIG. 6. For example, the data in each feature data set and each feature pattern data set can be summed, sampled, or otherwise restricted to a discrete value in a defined range of scalar values. The result of this quantization is shown as quantized data structure 630.

It will he apparent to those of ordinary skill in the art, that the quantization operation can be replaced by or followed by a hashing operation. Flashing means applying a hash function to specified data. A hash function is a procedure or mathematical fraction which typically converts a large, possibly variable-sized amount of data into a smaller amount of data. A hash function preferably includes a string hash function that can be used to generate a hash value that is unique or almost unique. Examples of a hash function include without limitation any MD (Message-Digest Algorithm), MD2 (Message-Digest Algorithm 2), MD3(Message Digest Algorithm 3), MD4 (Message-Digest Algorithm 4), MD5 (Message-Digest Algorithm 5) and MD6 (Message-Digest Algorithm 6). A hash value may also be referred to as a hash code, a hash sum, or simply a hash. Hash functions are mostly used to speed up table lookup or data comparison tasks, such as finding items in a database, detecting duplicated or similar records in a large file, and so on. A hash lookup, by using a hash table, preferably has a computational complexity of one unit of time. One unit of time refers to the computation time of a problem when the time needed to solve that problem is hounded by a value that does not depend on the size of the data it is given as input. For example, accessing any single element (e.g., hash value) in an array (e.g., hash table) takes one unit of time, as only one operation has to he performed to locate the element. For example, during a hash lookup, the hash value itself indicates exactly where in memory the hash value is supposed to be: the hash value is either there or not there. A hash value is a number that may he represented in a standardized format, such as, for example, a 128-bit value or a 32-digit hexadecimal number, or the like. The length of the hash value is determined by the type of algorithm used. The length of the hash value preferably depends on the number of entries in the system, and does not depend on the size of the value being hashed. Every pair of non-identical input data sets will likely translate into a different hash value, even if the two input data sets differ only by a single bit. Each time as particular input data set is hashed by using the same algorithm, the exact same, or substantially similar, hash value will be generated. For example, “MD5” is Message-Digest algorithm 5 hash function. The MDS function processes a variable-length message into a fixed-length output of 128 bits. The input data can be broken up into chunks of 512-bit blocks (sixteen 32-bit little endian integers). The input data can be padded so that its length is divisible by 512. The padding works as follows: first a single bit, 1, is appended to the end of the input data. This single bit is followed by as many zeros as are required to bring the length of the message up to 64 bits fewer than a multiple of 512. The remaining bits are filled up with a 64-bit integer representing the length of the original message, in bits. The main MD5 algorithm operates on a 128-bit state, divided into four 32-bit words, denoted A, B, C and D. These are initialized to certain fixed constants. The main MD5 algorithm then operates on each 512-bit message block in turn, each block modifying the state. The processing of an input data block comprises four similar stages, termed rounds. Each round comprises 16 similar operations based on a non-linear function F, modular addition, and left rotation.

Referring still to FIG. 6, in a next processing step, each of the elements of data structure 630 can be hashed as shown. For example, the quantized data in each feature data set and each feature pattern data set can be hashed in the manner described above. Alternatively, each of the elements of data structure 620 can be directly hashed. In this implementation, the quantization and hashing operations are combined. The result of this hashing operation is shown as hashed data structure 640, which can represent the anonymous object identifier corresponding to the object in the input data stream. Note that in data structure 640, each feature data set and each pattern data set, is separately or independently hashed. This format is convenient if a subsequent database lookup operation may need to search for matching objects on a feature-by-feature basis. In an alternative format, the entire data structure 640 can be hashed to produce a composite object hash value 650, which can also represent the anonymous object identifier corresponding to the object in the input data stream. As a result, the anonymous object identifier represents a unique, deterministic, identifier, code, or tag that corresponds to the particular visual characteristics of the object of interest. When the object of interest is a human face or a human form, the anonymous object identifier can be denoted as a biometric-based anonymous personal identifier.

In some circumstances, the objects shown in a particular image frame may be too indefinite, grainy, obscured, or unfocused to render useful object data. In these circumstances, the extracted features for the object may be too few or of inferior quality to provide an effective anonymous object identifier. Thus, one embodiment can score the quality of the object data set produced for a particular object. This quality score can be a composite of the quantity of features extracted and the quality of the extracted features for a particular object. An embodiment provides a configurable threshold parameter that can be set by a system operator. Any object data set produced for a particular object for which the quality score is below the configurable threshold parameter is discarded. Thus, when the analytic engine 260 is processing a particular data stream, the configurable threshold parameter can be used to retain only object data of a desired quality level.

Referring again to FIG. 5, the anonymous identifier processing module 2602 can also include an object tracking module 2614. The process of isolating objects, extracting features, and generating anonymous object identifiers for a particular image frame can be a computationally intensive process. As a result, it can be inefficient to perform this process for each object in each frame of an input data stream. To mitigate this problem, an embodiment uses the object tracking module 2614 to track a particular identified object as the object moves within a frame and from frame to frame in the input data stream. When a particular object is first encountered in an initial frame of the input data stream, the object is processed as described above and an anonymous object identifier is generated. However, once the object is identified and an identifier for the object is generated, the coordinates and/or pixel profile of the object can be tracked as the object moves within a frame and from frame to frame in the input data stream without the need to re compute the anonymous object identifier each time the identified object is encountered in a subsequent frame. As a result, the particular object can be identified once and tracked through the input data stream using the anonymous object identifier without having to re-compute the anonymous object identifier. In one embodiment, an object tracking method can be used as described in, Allen, John G., Xu, Richard Y. D., Jin, Jesse S. “Object Tracking Using CamShift Algorithm and Multiple Quantized Feature Spaces”, School of Information Technologies, University of Sydney, Madsen Building F09, University of Sydney, NSW 2006 (2004), incorporated herein by reference. This object tracking feature of an example embodiment described herein saves a significant amount of processing capacity, yet allows an object to be effectively tracked over time and location.

As described above, an anonymous object identifier can be generated for each object identified in an input data stream. The anonymous object identifiers can be stored in a database for data retention. Once the anonymous object identifier is created for a particular object, the anonymous object identifier and the pixel profile associated with the corresponding object can be used for tracking the object through an input data stream. When an object is identified in the input data stream and the anonymous object identifier is generated for the object, a database search for the anonymous object identifier can be performed. This database search can be used to determine if the object with the same anonymous object identifier has been encountered before in the input data stream or in any other data stream. Because the object features extracted from the object as described above correspond to the particular characteristics of the object appearing in the image data stream, these particular object features are likely to produce the same or similar anonymous object identifier in different frames or data streams. As a result, the anonymous object identifier can be used to identify the same object or person appearing in various places or at various times in one or more monitored venues 120. If the database search for the anonymous object identifier produces no matches, a new database record for the anonymous object identifier is created. Thus, the anonymous object identifier provides an effective way for the analytic engine 260 to track the activity of people or objects appearing in as monitored venue 120. In a visual display of activity in a monitored venue 120, the analytic. engine 260 can cause the generation of data to annotate each identified object with a tag or label corresponding to the object's anonymous object identifier. The anonymous object identifier can be used to track and log the activity for a particular person or object. The anonymous object identifier can be used to index into a database of logged activity and to compare logged activity to activity known to be suspicious or alert-worthy. This comparison can be accomplished using the rules manager 250 as described above. If a particular person or object is determined to he engaged in suspicious activity, the tag or label corresponding to the person or object can be highlighted on the visual display. Because the anonymous object identifier can be generated strictly from the image data and without any information related to the personal identity of the imaged individual, the tag or label applied to each person shown on the visual display can be anonymous to the particular person. The anonymous object identifier can also he used to index into a database of known wants/warrants, affiliates, personal identity information, and a variety of other data collections related to people or objects of interest. In these ways, the anonymous object identifier can provide an effective means for anonymously identifying and tracking people and other objects in a monitored venue.

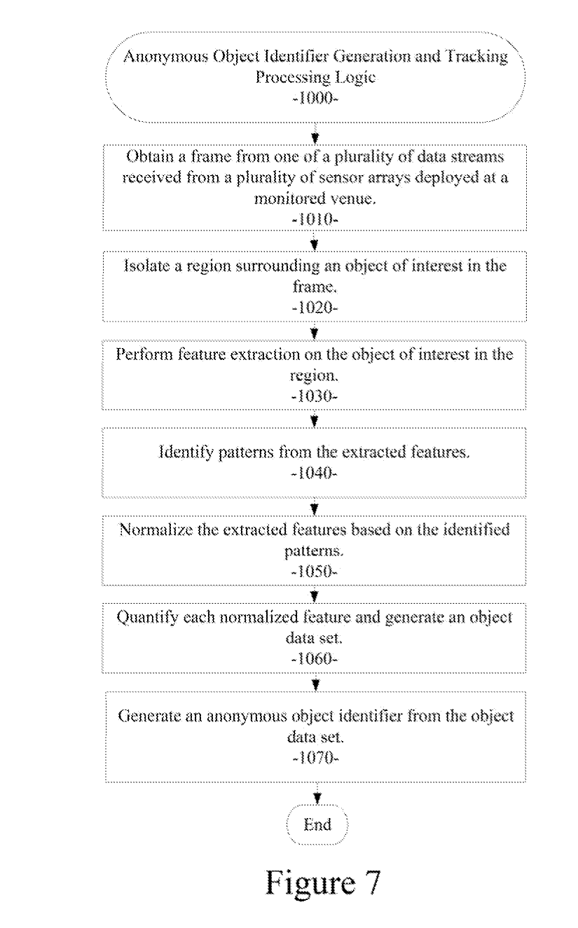

FIG. 7 is a processing flow diagram illustrating an example embodiment of a system and method for anonymous object identifier generation and usage for tracking as described herein. The method of an example embodiment includes: obtaining a frame from one of a plurality of data streams received from a plurality of sensor arrays deployed at a monitored venue (processing block 1010); isolating a region surrounding an object of interest in the frame (processing block 1020); performing feature extraction on the object of interest in the region (processing block 1030); identifying patterns from the extracted features (processing block 1040); normalizing the extracted features based on the identified patterns (processing block 1050); quantifying each normalized feature and generating an object data set (processing block 1060); and generating an anonymous object identifier from the object data set (processing block 1070).

Referring again to FIG. 2, the data analyzer 2603 performs a high level data analysis of the information gathered and processed by the analytic engine 260. The data analyzer 2603 can perform a linkage analysis to connect groups of people and/or objects identified in a monitored venue. This linkage analysis can use other sources of intelligence, surveillance, or other processed information to draw inferences, predict potential activities or outcomes, and propose actions to address the potential activities or outcomes. In one embodiment, this information can be used to cause the generation of alerts or pre-alerts.

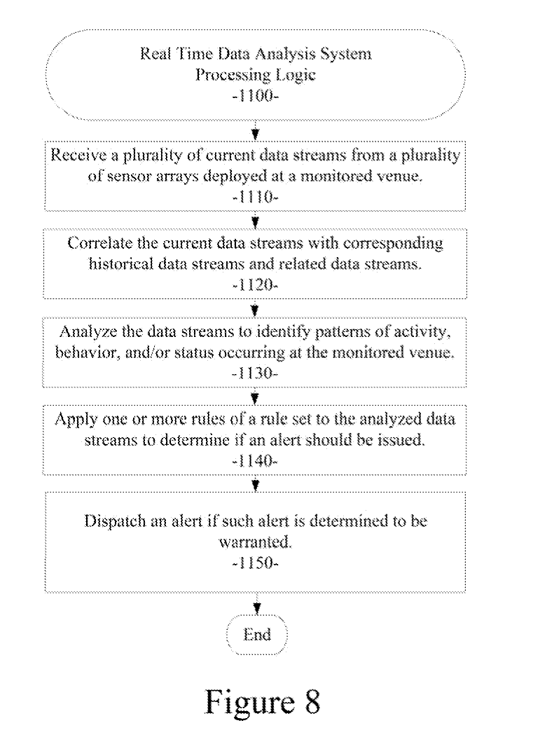

FIG. 8 is a processing flow diagram illustrating an example embodiment of a system and method for real time data analysis as described herein. The method of an example embodiment includes: receiving a plurality of current data streams from a plurality of sensor arrays deployed at a monitored venue (processing block 1110); correlating the current data streams with corresponding historical data streams and related data streams (processing block 1120); analyzing, by use of a data processor, the data streams to identify patterns of activity, behavior, and/or status occurring at the monitored venue (processing block 1130); applying one or more rules of a rule set to the analyzed data streams to determine if an alert should be issued (processing block 1140); and dispatching an alert if such alert is determined to be warranted (processing block 1150).

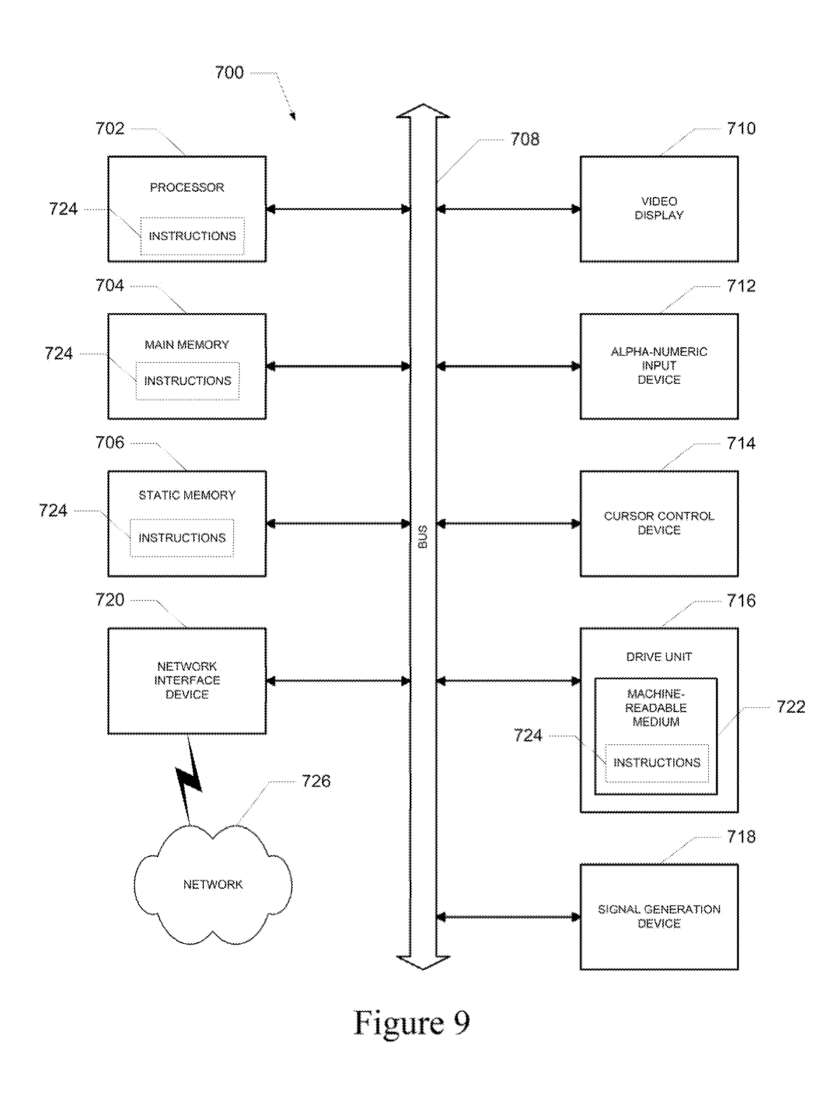

FIG. 9 shows a diagrammatic representation of a machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer for distributed) network environment. The machine may be a personal computer (PC), as tablet PC, a set-top box (STB), a Personal Digital Assistant (PDA), a cellular telephone, a we appliance, a network router, switch or bridge, a video camera, image or audio capture device, sensor device, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., as liquid crystal display (LCD) or a cathode ray tube (CRT)), The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted, as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method comprising:
obtaining a frame from one of a plurality of data streams received from a plurality of sensor arrays deployed at a monitored venue;
isolating a region surrounding an object of interest in the frame;
using at data processor to perform feature extraction on the object of interest in the region;
identifying patterns from the extracted features;
normalizing the extracted features based on the identified patterns;
quantifying each normalized feature and generating an object data set; and
generating an anonymous object identifier from the object data set.

2. The method as claimed in claim 1 wherein the monitored venue is a mobile venue.

3. The method as claimed in claim 1 wherein the frame is a video frame.

4. The method as claimed in claim 1 wherein the object of interest is an image of a human face.

5. The. Method as claimed in claim 4 wherein the extracted features include biometric characteristics of the image of the human face.

6. The method as claimed in claim 1 wherein normalizing includes rotating the object of interest.

7. The method as claimed in claim 1 wherein generating an object data set includes combining a feature data set and a pattern data set into the object data set.

8. The method as claimed in claim 1 wherein generating the anonymous object identifier includes hashing the object data set.

9. The method as claimed in claim 1 wherein generating the anonymous object identifier includes hashing independent elements of the object data set.

10. A system comprising:
a plurality of sensor arrays deployed at a monitored venue; and
a real time data analysis operations center in data communication with the plurality of sensor arrays via a wired or wireless network, the real time data analysis operations center including computing modules to:
obtain a frame from one of a plurality of data streams received from a plurality of senor arrays deployed at a monitored venue;
isolate a region surrounding an object of interest in the frame;
perform feature extraction on the object of interest in the region;
identify patterns from the extracted features;
normalize the extracted. features based on the identified patterns;
quantify each normalized feature and generating an object data set; and
generate an anonymous object identifier from the object data set.

11. The system as claimed in claim 10 wherein the monitored venue is a mobile venue.

12. The system as claimed in claim 10 wherein the frame is a video frame.

13. The system as claimed m claim 10 wherein the object of interest is an image of a human

14. The system as claimed in claim 13 wherein the extracted features include biometric characteristics of the image of the human face.

15. The system as claimed in claim 10 being further configured to rotate the object of interest.

16. The system as claimed in claim 10 being further configured to combine a feature data set and a pattern data set into the object data set.

17. The system as claimed in claim 10 being further configured to generate the anonymous object identifier by hashing the object data set.

18. The system as claimed in claim 10 being further configured to generate the anonymous object identifier by hashing independent elements of the object data set.

19. A non-transitory machine-useable storage medium embodying instructions which, when executed by a machine, cause the machine to:
obtain a frame from one of a plurality of data streams received from a plurality of sensor arrays deployed at a monitored venue;
isolate a region surrounding an object of interest in the frame;
perform feature extraction on the object of interest in the region;
identify patterns from the extracted features;
normalize the extracted features based on the identified patterns;
quantify each normalized feature and generating an object data set; and
generals an anonymous object identifier from the object data set.

20. The machine-useable storage medium as claimed in claim 19 wherein the monitored venue is a mobile venue.
